(19) United States
(12) Patent Application Publication
(10) Pub. No.: US 2025/0288966 A1
(43) Pub. Date: Sep. 18, 2025

(54) AGITATION APPARATUS AND SPRAYING SYSTEM

(71) Applicant: SAKURA RUBBER CO., LTD., Tokyo (JP)

(72) Inventors: Hiroshi Nakamura, Tokyo (JP); Katsutoshi Takeuchi, Tokyo (JP); Atsushi Hirayama, Tokyo (JP)

(73) Assignee: SAKURA RUBBER CO., LTD., Tokyo (JP)

(21) Appl. No.: 19/224,042

(22) Filed: May 30, 2025

Related U.S. Application Data
(63) Continuation of application No. PCT/JP2023/020996, filed on Jun. 6, 2023.

(30) Foreign Application Priority Data
Nov. 30, 2022 (JP) 2022-191829

(51) Int. Cl. B01F 31/20; B05B 15/50

(52) U.S. Cl. CPC B01F 31/265; B05B 15/50

(57) ABSTRACT

An agitation apparatus according to one embodiment is an agitation apparatus for use in a container which contains contents and extends in a first direction. The agitation apparatus includes a holder to which the container is attached and a converting member coupled to the holder. The converting member includes an input member which rotates about an axis, and an output member coupled to the holder to output a rotational motion of the input member as a linear motion along the first direction and a direction opposite to the first direction. When the input member rotates about the axis, the container attached to the holder moves linearly together with the output member.

### CROSS-REFERENCE TO RELATED APPLICATIONS

This application is a Continuation Application of PCT Application No. PCT/JP2023/020996, filed Jun. 6, 2023 and based upon and claiming the benefit of priority from prior Japanese Patent Application No. 2022-191829, filed Nov. 30, 2022, the entire contents of all of which are incorporated herein by reference.

### BACKGROUND OF THE INVENTION

### 1. Field of the Invention

The present invention relates to an agitation apparatus and a spraying system.

### 2. Description of the Related Art

Conventionally, a container such as a spray can may be used as a spraying apparatus for spraying paint or the like (for example, JP 2017-221889 A). The container is filled with, e.g., contents including a curing retarding agent, a spray agent and the like. Before using the spraying apparatus, the contents of the container need to be agitated. For example, the user holds the spray can in his hand and shakes it in the vertical direction, the horizontal direction and the like to agitate the contents.

If, however, the user's agitation is insufficient, the contents may not be mixed. This may cause variations in the quality of the contents sprayed from the spraying apparatus.

### BRIEF SUMMARY OF THE INVENTION

It is an object of the present invention to provide an agitation apparatus and a spraying system which are capable of achieving satisfactory spraying of contents of a container.

An agitation apparatus according to one embodiment is an agitation apparatus for use in a container which contains contents and extends in a first direction. The agitation apparatus comprises a holder to which the container is attached and a converting member coupled to the holder. The converting member includes an input member which rotates about an axis, and an output member coupled to the holder to output a rotational motion of the input member as a linear motion along the first direction and a direction opposite to the first direction. When the input member rotates about the axis, the container attached to the holder moves linearly together with the output member in the first direction and a direction opposite to the first direction.

The input member may include a first input shaft coupled to an output shaft of a rotation driving unit of a driving source. The axis may extend along a second direction orthogonal to the first direction. The output member may further include an output portion coupled to the holder and extending in the first direction. The agitation apparatus may further comprise a sliding member. The sliding member may include a rail extending in the first direction and a slider provided movably along the rail, and the rail may be coupled to the output member of the converting member and may linearly move in the first direction and a direction opposite to the first direction with respect to the input member of the converting member. The converting member may further include a case coupled to the slider and contains at least part of the input member and the output member. The input member may project in a direction opposite to the second direction from the case, and the output member may project in the first direction from the case. The input member may include a rotating plate provided at an end portion of the first input shaft to rotate about the axis together with the first input shaft, and a pin provided on the rotating plate, projecting in the second direction and provided away from the axis. The output member may include a pin inserting portion connected to the output portion and where the pin is located. The holder may further include a grip extending in the first direction and spaced from the rail. The holder may include a plurality of attaching portions for attaching a plurality of containers.

A spraying system according to one embodiment comprises the agitation apparatus and a power tool including a rotation driving unit couplable to the input member. The spraying system may further comprise an attachment including a second input shaft couplable to the rotation driving unit and an output shaft couplable to the input member. The container may be a spray can capable of spraying the contents. The holder may further include a trigger to operate a valve of the container. The agitation apparatus may further include a spraying nozzle attached to the holder and having a spraying hole through which the contents are sprayed.

With the foregoing configuration, an agitation apparatus and a spraying system which are capable of achieving satisfactory spraying of contents of a container can be provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic perspective view of a spraying system according to an embodiment.

FIG. 2 is a schematic partial side view showing an example of a first attaching portion and a second attaching portion of a holder.

FIG. 3 is a schematic partial plan view showing an example of the first attaching portion and second attaching portion of the holder.

FIG. 4 is a schematic side view of an agitation apparatus according to the embodiment.

FIG. 5 is a schematic plan view of the agitation apparatus according to the embodiment.

FIG. 6 is a schematic back view of the agitation apparatus according to the embodiment.

FIG. 7 is a diagram showing an example of a structure applicable to a converting member of the agitation apparatus.

FIG. 8 is a diagram showing an example of the structure applicable to the converting member of the agitation apparatus.

FIG. 9 is a diagram showing an example of the structure applicable to the converting member of the agitation apparatus.

FIG. 10 is an illustration of the movement of the converting member.

FIG. 11 is a schematic partial sectional view showing an example of the structure of a first container.

### DETAILED DESCRIPTION OF THE INVENTION

On embodiment of the present invention will be described below with reference to the drawings. The disclosure of each of the embodiments is nothing but one example, and a change in matter in the disclosure, which could easily be conceived by a person with ordinary skill in the art without departing from the subject matter of the invention, can be included in the scope of the present invention. In addition, the drawings do not define the interpretation of the present invention though they may show each component more schematically than in the actual aspect in order to clarify the descriptions of the invention.

In each of the drawings, the symbols may be omitted for the same or similar components arranged consecutively. In addition, in the specification and each drawing, components that perform the same or similar function as that described in the preceding drawings may be denoted by the same reference symbols, and their redundant detailed descriptions may be omitted.

In the drawings, X, Y and Z axes which are orthogonal to each other are shown. The direction along the X axis is referred to as an X direction, the direction along the Y axis is referred to as a Y direction, and the direction along the Z axis is referred to as a Z direction. The Z direction Z a direction normal to the plane including the X direction and the Y direction. In the present embodiment, the X direction corresponds to a second direction, and the Z direction corresponds to a first direction.

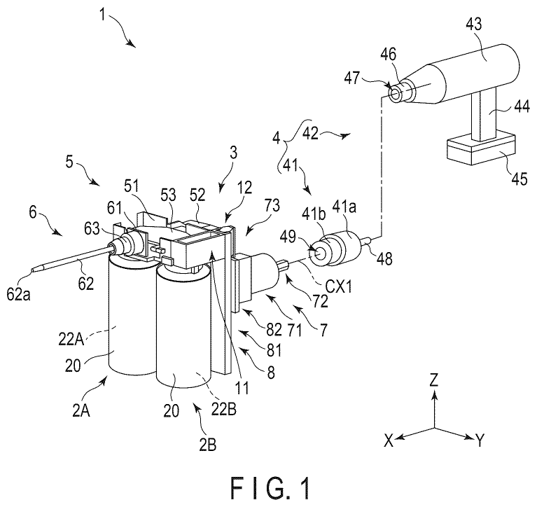

FIG. 1 is a schematic perspective view of a spraying system 1 according to the present embodiment. In the present embodiment, a two-liquid mixture type spraying system 1 will be described as an example. The spraying system 1 is, in one example, a polyurea spraying system. Polyurea is used as a lining material in various facilities such as concrete structures and metal tanks.

The spraying system 1 includes a first container 2A, a second container 2B, an agitation apparatus 3 and a driving unit 4. The first and second containers 2A and 2B are, for example, spray cans (aerosol containers). However, the first and second containers 2A and 2B may be containers other than spray cans.

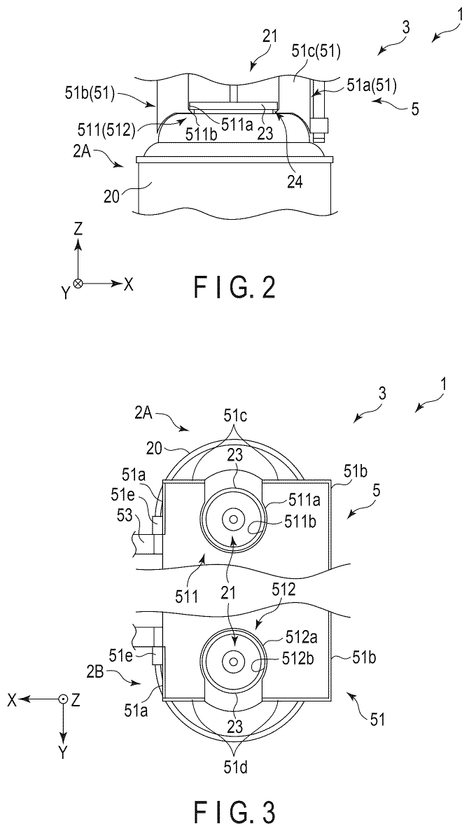

Each of the first and second containers 2A and 2B includes a cylindrical container body 20. The container body 20 has, for example, a long shape extending in the Z direction. A valve 21 (shown in FIGS. 2 and 3) is provided on the top of each container body 20.

The first container 2A contains contents 22A, and the second container 2B contains contents 22B. The first and second containers 2A and 2B may further contain agitation tools for agitating the contents 22A and 22B, respectively.

If the valves 21 are opened, the contents 22A and 22B of the first and second containers 2A and 2B are sprayed. Each component of the container body 20 may be formed of a metal material, for example, but may include a member formed of a resin material or the like.

The first and second containers 2A and 2B each contain a polyurea material. Specifically, the first container 2A is filled with, as the contents 22A, a material obtained by adding a curing retarding agent and a spraying agent to an A agent containing isocyanate as a main component.

The isocyanate is preferably an aromatic isocyanate such as 4,4′-diphenylmethane diisocyanate (4,4′-MDI), 2,4-tolylene diisocyanate (2,4-TDI), and 2,6-tolylene diisocyanate (2,6-TDI). Note that the isocyanate may be an aliphatic isocyanate. The A agent may be a mixture obtained by reacting part of these isocyanates with a polyol to form a urethane prepolymer.

The curing retarding agent is compatible with the A agent to reduce the viscosity of the A agent. An example of the curing retarding agent is methyl ethyl ketone (MEK). The curing retarding agent may be any solvent having excellent compatibility with isocyanate and polyamine, and various general-purpose solvents such as acetone can be used.

As the spraying agent, a liquefied gas spraying agent or a compressed gas spraying agent can be used. Examples of the liquefied gas spraying agent include a liquefied gas spraying agent such as dimethyl ether (DME) or liquefied petroleum gas (LPG). Examples of the spraying agent of the compressed gas system include compressed carbon dioxide gas and nitrogen gas. In the present embodiment, it is preferable to use a liquefied gas spraying agent. Since the liquefied gas spraying agent is a liquid phase in the containers, it contributes to a reduction in the viscosity of the A agent.

The second container 2B is filled with, as the contents 22B, a material obtained by adding a curing retarding agent and a spraying agent similar to those of the first container 2A to a B agent containing polyamine as a main component. The curing retarding agent and liquefied gas spraying agent reduce the viscosity of the B agent.

An example of the blending ratio (volume ratio) of the curing retarding agent and spraying agent to the A agent or B agent is A agent or B agent:methyl ethyl ketone:dimethyl ether (liquid phase)=7:3:10. Preferably, 20 to 40 mL of the curing retarding agent is contained to a total of 100 mL of the A agent (B agent) and the curing retarding agent. If the amount of curing retarding agent is less than 20 mL, the start of reaction of the A agent (B agent) may be accelerated and thus the materials may not be sufficiently mixed. If the amount of curing retarding agent exceeds 40 mL, there is a possibility of liquid dripping when the curing retarding agent is applied to a wall or the like. In the case of the liquid phase, the amount of spraying agent is preferably about the same as the sum of the A agent (B agent) and the curing retarding agent by volume.

The B agent is a mixture of polyamine with an average molecular weight of 1000 to 10000 and aromatic diamine. As the polyamine, for example, polyalkylene amine such as polyoxypropylenediamine is preferable. Examples of the aromatic diamine include diethyltoluenediamine, 4,4′-methylenebis (N-sec-butylaniline) and a mixture thereof. The blending ratio of the B agent is, for example, 20 to 40 parts by weight of aromatic diamine to 100 parts by weight of polyamine.

The agitation apparatus 3 is used, for example, to agitate the contents contained in a container extending in the Z direction such as the first and second containers 2A and 2B. The agitation apparatus 3 has a function as a spraying apparatus for spraying the contents 22A and 22B of the first and second containers 2A and 2B. The agitation apparatus 3 includes a holder 5, a spraying nozzle 6, a converting member 7 and a sliding member 8.

The first and second containers 2A and 2B are attached to the holder 5. The holder 5 includes a base 51, a grip 52 and a trigger 53. Each components of the holder 5 is formed of, for example, a resin material. The base 51 is detachable from the first and second containers 2A and 2B. The grip 52 and trigger 53 are attached to the base 51. The user grips the grip 52. The grip 52 extends along the Z direction.

The trigger 53 allows the user to operate the valves 21 of the first and second containers 2A and 2B. The trigger 53 is located above the valves 21 of the first and second containers 2A and 2B.

The base 51 further includes a plurality of attaching portions for attaching the first and second containers 2A and 2B. The attaching portions can be held so that the first and second containers 2A and 2B are not detached from the base 51 when the holder 5 moves linearly.

A configuration applicable to the attaching portions will now be described with reference to FIGS. 2 and 3. FIG. 2 is a schematic partial side view showing an example of a first attaching portion 511 and a second attaching portion 512 of the holder S. FIG. 3 is a schematic partial plan view showing an example of the first and second attaching portions 511 and 512 of the holder 5. In FIG. 2, the agitation apparatus 3 is viewed in the Y direction, and the vicinity of the first attaching portion 511 is shown. In FIG. 3, the trigger 53 is opened to the base 51.

In the example shown in FIGS. 2 and 3, the base 51 includes a pair of front walls 51a, a pair of rear walls 51b and a pair of side walls 51c and 51d. The trigger 53 is located in a space surrounded by these front, rear and side walls 51a, 51b, 51c and 51d. The trigger 53 is rotatably supported around a hinge 51e provided on the pair of front walls 51a.

The base 51 further includes a first attaching portion 511 and a second attaching portion 512. For example, the first container 2A is attached to the first attaching portion 511, and the second container 2B is attached to the second attaching portion 512.

In the example shown in FIGS. 2 and 3, the first attaching portion 511 includes an arcuate recess portion 511a and an arcuate claw 511b projecting from the inner peripheral surface of the recess portion 511a. As shown in FIG. 2, a ring-shaped projection 23 of the first container 2A is fit into the recess portion 511a of the first attaching portion 511. As shown in FIG. 2, a step 24 is provided on the outer peripheral surface of the ring-shaped projection 23, and the claw 511b of the first attaching portion 511 is hooked to the step 24.

The second container 2B is also attached to the second attaching portion 512 as well as the first attaching portion 511. In the example shown in FIG. 3, the second attaching portion 512 includes an arcuate recess portion 512a and an arcuate claw 512b projecting from the inner peripheral surface of the recess portion 512a.

A ring-shaped projection 23 of the second container 2B is fit into the recess portion 512a of the second attaching portion 512, and a claw 512b of the second attaching portion 512 is hooked to the step 24 on the outer peripheral surface of the ring-shaped projection 23.

Note that the first and second attaching portions 511 and 512 have only to be used to attach the first and second containers 2A and 2B to the holder 5, which is not limited to the examples shown in FIGS. 2 and 3.

As shown in FIG. 1, the spraying nozzle 6 includes an adapter 61, a static mixer 62 and a fixture 63. The adapter 61 is attached to the base 51. The adapter 61 is connected to the valves 21 of the first and second containers 2A and 2B through, for example, a tube (not shown). The proximal end of the static mixer 62 is connected to the adapter 61. The adapter 61 and the static mixer 62 are fixed by the fixture 63.

The static mixer 62 mixes the A agent of the first container 2A sent through the adapter 61 and the B agent of the second container 2B sent through the adapter 61. A plurality of elements whose rotational directions are alternately switched are arranged in the static mixer 62.

If the user pushes the trigger 53 downward with the thumb of the hand that grips the grip 52, the trigger 53 rotates about the hinge 51e. At this time, if the trigger 53 pushes the valves 21 of the first and second containers 2A and 2B downward, these valves 21 are simultaneously opened. As the valves 21 are opened, the A agent of the first container 2A and the B agent of the second container 2B are supplied to the static mixer 62.

As the A and B agents pass through the static mixer 62, they are agitated and mixed by the elements to produce polyurea. The produced polyurea is sprayed from a spraying hole 62a of the static mixer 62.

As shown in FIG. 1, the driving unit 4 includes a driving source and an attachment 41. The driving source is, for example, a power tool 42. The power tool 42 is, in one example, an electric hand drill. The power tool 42 has a main body 43, a grip 44 and a battery 45.

The main body 43 has a rotation driving unit 46 at its end portion. The rotation driving unit 46 rotates around an axis parallel to the X direction. The rotation driving unit 46 has an output shaft 47. The output shaft 47 is a hollow shaft in the example shown in FIG. 1. The output shaft 47 rotates about an axis parallel to the X direction together with the rotation driving unit 46.

The attachment 41 includes an input portion 41a having an input shaft 48 (second input shaft) and an output portion 41b having an output shaft 49. The input shaft 48 is, for example, a solid shaft. The output shaft 49 is, for example, a hollow shaft. The axis of the input shaft 48 and that of the output shaft 49 are parallel to the X direction in the example shown in FIG. 1. The axis of the input shaft 48 is coaxial with that of the output shaft 49.

In the example shown in FIG. 1, the input shaft 48 of the attachment 41 is coupled to the output shaft 47 of the rotation driving unit 46 of the power tool 42, and the output shaft 49 of the attachment 41 is coupled to the converting member 7.

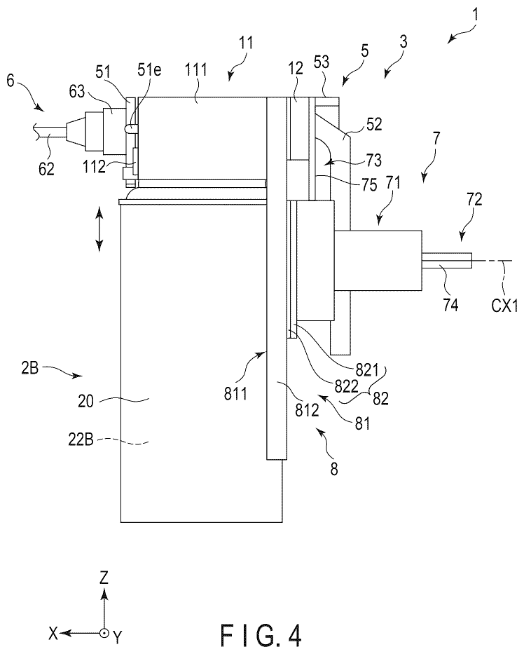

Then, the converting member 7, sliding member 8 and the like of the agitation apparatus 3 will be described with reference to FIGS. 4 to 6.

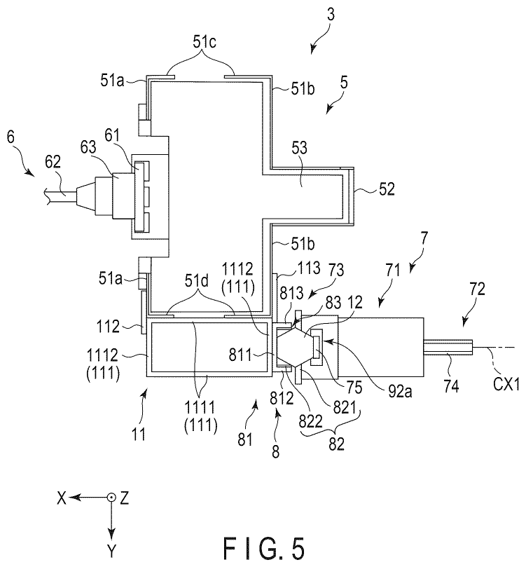

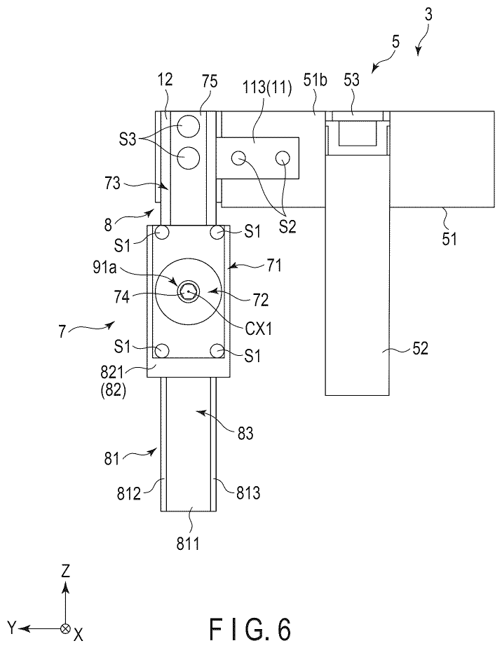

FIG. 4 is a schematic side view of the agitation apparatus 3 according to the present embodiment. FIG. 5 is a schematic plan view of the agitation apparatus 3 according to the present embodiment. FIG. 6 is a schematic back view of the agitation apparatus 3 according to the present embodiment. In FIG. 4, the agitation apparatus 3 is viewed in a direction opposite to the Y direction. In FIGS. 5 and 6, some members of the first and second containers 2A and 2B, etc., are not shown.

The agitation apparatus 3 includes the converting member 7 and sliding member 8 as described above. As shown in FIGS. 5 and 6, the converting member 7 and sliding member 8 are spaced in the Y direction from the grip 52 of the holder 5.

The converting member 7 converts the rotational motion to the linear motion. The converting member 7 includes a case 71, an input member 72 and an output member 73. The case 71 contains at least part of the input member 72 and output member 73. The case 71 is formed, for example, of a resin material, but may also be formed of a metal material. The case 71 is configured by, for example, a plurality of members.

The input member 72 rotates about the axis CX1. The axis CX1 extends along the X direction. The input member 72 has an input shaft 74 (first input shaft). The input shaft 74 is coupled to the output shaft 47 of the rotation driving unit 46 of the power tool 42 via the attachment 41. The input shaft 74 is, for example, a solid shaft. The input shaft 74 projects in a direction opposite to the X direction from the case 71.

The output member 73 outputs the rotational motion of the input member 72 as a linear motion along the Z direction and a direction opposite to the Z direction. The output member 73 has an output portion 75. The output portion 75 projects in the Z direction from the case 71. The output portion 75 moves linearly above the case 71.

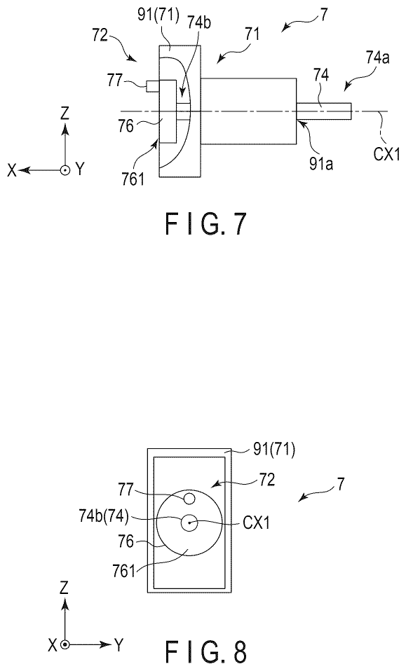

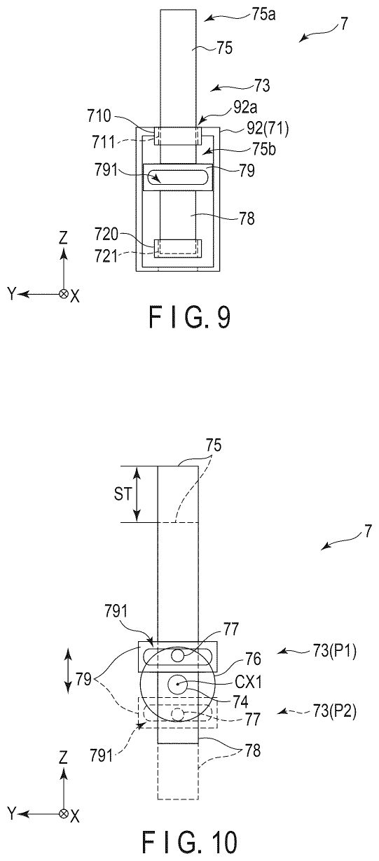

The configuration applicable to the converting member 7 will now be described with reference to FIGS. 7 to 9. FIGS. 7 to 9 are diagrams each showing an example of the configuration applicable to the converting member 7 of the agitation apparatus 3. FIGS. 7 and 8 show mainly the input member 72, and FIG. 9 shows mainly the output member 73.

The input member 72 is formed of a metal material, for example, but may be formed of a resin material or the like. The input member 72 is provided, for example, in a first case portion 91 of the case 71. A through hole 91a through which the input shaft 74 is inserted is formed in the first case portion 91. The through hole 91a may be provided with a bearing or the like to support the input shaft 74.

As shown in FIGS. 7 and 8, the input member 72 includes an input shaft 74, a rotating plate 76 and a pin 77. The input shaft 74, rotating plate 76 and pin 77 are formed integrally as one unit, for example.

The input shaft 74 extends along the X direction. The input shaft 74 has a first end portion 74a and a second end portion 74b located on the opposite side of the first end portion 74a. The first end portion 74a is located outside the case 71, and the second end portion 74b is located inside the case 71. The first end portion 74a is coupled to the output shaft 47 of the rotation driving unit 46 via the attachment 41.

The first end portion 74a has, for example, a prismatic shape. In one example, the first end portion 74a has a hexagonal prism shape. As another example, the input shaft 74 may have a cylindrical shape. The second end portion 74b has, for example, a cylindrical shape. As another example, the second end portion 74b may have a cylindrical shape.

The rotating plate 76 and pin 77 rotate about the axis CX1 together with the input shaft 74. The rotating plate 76 and pin 77 are housed in the case 71. The rotating plate 76 is provided at the second end portion 74b of the input shaft 74. The rotating plate 76 has, for example, a disk shape.

The axis of the rotating plate 76 is located coaxially with the axis CX1. The rotating plate 76 has a surface 761. The surface 761 is opposed to the output member 73 in the X direction. The surface 761 is a plane substantially parallel to the Y-Z plane defined by the Y and Z directions.

The pin 77 is provided on the surface 761. The pin 77 has a cylindrical shape, for example. The pin 77 projects in the X direction from the surface 761. In other words, the pin 77 projects from the surface 761 toward the output member 73. The pin 77 is provided away from the axis CX1. In other words, the axis of the pin 77 is not located coaxially with the axis CX1.

The output member 73 is formed of a metal material, for example, but may be formed of a resin material or the like. The output member 73 has, for example, a flat plate shape. The output member 73 is provided, for example, in a second case portion 92 of the case 71.

The second case portion 92 is so configured to be combined with the first case portion 91. In the second case portion 92, a through hole 92a through which the output portion 75 is inserted is formed. The through hole 92a has a substantially rectangular shape when viewed in a direction opposite to the Z direction.

The output member 73 includes an output portion 75, a guide portion 78 and a pin inserting portion 79. The output portion 75, pin inserting portion 79 and guide portion 78 are, for example, formed integrally as one unit.

The output portion 75 has a long, substantially rectangular shape extending in the Z direction when viewed in the X direction. The output portion 75 has a third end portion 75a and a fourth end portion 75b located on the opposite side of the third end portion 75a.

The third end portion 75a is located outside the case 71, and the fourth end portion 75b is located inside the case 71. The guide portion 78 has a long, substantially rectangular shape in the Z direction when viewed in the X direction. The guide portion 78 is located below the output portion 75.

The pin inserting portion 79 is located between the output portion 75 and the guide portion 78 in the Z direction. The pin inserting portion 79 is connected to the fourth end portion 75b. The pin inserting portion 79 has a long shape in the Y direction. The pin inserting portion 79 has a long hole 791 elongated in the Y direction. The long hole 791 penetrates the output member 73 in the X direction. The pin 77 of the input member 72 is located in the long hole 791.

The converting member 7 may further include support members 710 and 720 as in the example shown in FIG. 9. The support member 710 has a through hole 711 through which the output portion 75 is inserted, and the support member 720 has a through hole 721 through which the guide portion 78 is inserted.

The output portion 75 and guide portion 78 are respectively inserted through the through holes 711 and 721 of the support members 710 and 720 and thus their movements are supported in the Z direction and a direction opposite to the Z direction. The pin inserting portion 79 can be moved in the Z direction and the direction opposite to the Z direction between the support members 710 and 720.

Next is a description of the movement of the converting member 7. FIG. 10 is an illustration of the movement of the converting member 7. In FIG. 10, the case 71 and the like are omitted for convenience of description. In the combined state of the input member 72 and the output member 73, the pin 77 of the input member 72 is located in the long hole 791 of the pin inserting portion 79 of the output member 73.

In FIG. 10, the solid lines indicate the output member 73 and pin 77 at the position where the amount of projection of the output portion 75 of the output member 73 relative to the case 71 is the largest (hereinafter referred to as first position P1). In FIG. 10, the broken lines indicate the output member 73 and pin 77 at the position where the amount of projection of the output portion 75 of the output member 73 relative to the case 71 is the smallest (hereinafter referred to as second position P2).

If the input shaft 74 rotates about the axis CX1 by 180 degrees from the first position P1, the pin 77 rotates about the axis CX1 by 180 degrees together with the rotating plate 76. The pin 77 is provided away from the axis CX1. Therefore, the pin 77 pushes the inner peripheral surface of the long hole 791 in a direction opposite to the Z direction, and the output member 73 moves downward, with the result that the output portion 75 is located from the first position P1 to the second position P2.

If, furthermore, the input shaft 74 rotates about the axis CX1 by 180 degrees from the second position P2, the pin 77 rotates about the axis CX1 by 180 degrees together with the rotating plate 76. At this time, the pin 77 pushes the inner peripheral surface of the long hole 791 of the pin inserting portion 79 in the Z direction, and the output member 73 moves upward, with the result that the output portion 75 is located from the second position P2 to the first position P1.

As the pin 77 rotates along with the rotation of the input shaft 74, the position of the output portion 75 is alternately switched between the first and second positions P1 and P2. In other words, the output portion 75 reciprocates along the Z axis as indicated by the arrows in FIG. 10.

As described above, the converting member 7 converts the rotational motion of the input member 72 into a linear motion of the output member 73 along the Z direction and the direction opposite to the Z direction. Note that the converting member 7 has only to be able to convert the rotational motion of the input member 72 into the linear motion of the output member 73, which is not limited to the examples shown in FIGS. 7 to 10.

The distance of movement of the output portion 75 between the first and second positions P1 and P2 may be referred to as a stroke ST (shown in FIG. 10), and the number of times the output portion 75 reciprocates per unit time may be referred to as a pitch.

The stroke ST can be adjusted, for example, by adjusting the distance from the axis CX1 to the pin 77. More specifically, the stroke ST is increased by increasing the distance from the axis CX1 to the pin 77, and the stroke ST is decreased by decreasing the distance from the axis CX1 to the pin 77.

The pitch can be adjusted by the number of rotations per unit time of the input shaft 74. More specifically, the pitch is increased by increasing the number of rotations of the input shaft 74 per unit time, and the pitch is decreased by decreasing the number of rotations of the input shaft 74 per unit time.

As shown in FIGS. 4 to 6, the sliding member 8 includes a rail 81 and a slider 82. The rail 81 extends along the Z direction. As shown in FIG. 6, the rail 81 is located alongside and away from the grip 52 of the holder 5 in the Y direction. The rail 81 and the grip 52 of the holder 5 are provided side by side in the Z direction.

The rail 81 has a first wall 811 and a pair of second walls 812 and 813. These walls 811, 812 and 813 are formed integrally as one unit. The first wall 811 is provided along the Y-Z plane.

The second walls 812 and 813 is provided along an X-Z plane defined by the X and Z directions. The second wall 812 and 813 is provided at both end portions of the first wall 811 in the Y direction. The second wall 812 is opposed to the second wall 813 at intervals in the Y direction. A groove 83 is formed by the first and second walls 811, 812 and 813.

The slider 82 is provided movably along the rail 81. The slider 82 includes an attaching portion 821 and a supporting portion 822 coupled to the attaching portion 821. In one example, the attaching portion 821 has a flat plate shape.

The case 71 of the converting member 7 is attached to the attaching portion 821. The attaching portion 821 is fixed to the case 71 by, for example, a plurality of (e.g., four) fixing members S1 (shown in FIG. 6). The fixing members S1 are configured by, for example, a bolt and a nut. The bolt is inserted through, for example, through holes formed in the case 71 and the attaching portion 821. The fixing member S1 may be an adhesive or the like.

The supporting portion 822 is located between the first wall 811 and the attaching portion 821. The supporting portion 822 is movable along the groove 83 in the Z direction and in a direction opposite to the Z direction. In other words, the supporting portion 822 supports the attaching portion 821 movably relative to the rail 81. The supporting portion 822 includes, for example, a plurality of rollers that move along the groove 83.

As shown in FIGS. 4 to 6, the agitation apparatus 3 further includes a first coupling member 11 and a second coupling member 12. The first and second coupling members 11 and 12 are members for coupling the converting member 7 and the sliding member 8 to the holder 5.

The first coupling member 11 couples the rail 81 of the sliding member 8 to the base 51 of the holder 5. The first coupling member 11 is formed of, for example, a metal material, but may be formed of a resin material or the like.

The first coupling member 11 has a body portion 111 and projecting portions 112 and 113 projecting from the body portion 111 in a direction opposite to the Y direction. The body portion 111 and projecting portions 112 and 113 are, for example, formed integrally as one unit.

The body portion 111 has a cylindrical shape, for example. The body portion 111 has, for example, a long rectangular shape in the X direction when viewed in the direction opposite to the Z direction. The body portion 111 has a pair of side walls 1111 and a pair of side walls 1112.

The sidewalls 1111 extend in the X direction and are arranged in the Y direction when viewed in the direction opposite to the Z direction. The sidewalls 1112 extend in the Y direction and are arranged in the X direction when viewed in the direction opposite to the Z direction.

When viewed in the direction opposite to the Z direction, the sidewalls 1111 corresponds to the long side of the body portion 111, and the sidewalls 1112 corresponds to the short side of the body portion 111. In the example shown in FIG. 5, one of the paired sidewalls 1111 is in contact with the sidewall 51d of the base 51 of the holder 5, and one of the paired sidewalls 1112 is in contact with the rail 81 of the sliding member 8.

The projecting portions 112 and 113 are provided on the paired side walls 1112. The projecting portions 112 and 113 extend in a direction opposite to the Y direction and are arranged in the X direction. For example, the projecting portions 112 and 113 has a long rectangular shape in the Y direction when viewed in the X direction. The shapes of the projecting portions 112 and 113 are not limited to this example.

The projecting portions 112 and 113 are coupled to the holder 5. More specifically, as shown in FIG. 5, the projecting portion 112 is coupled to the front walls 51a of the base 51 of the holder 5, and the projecting portion 113 is coupled to the rear walls 51b of the base 51 of the holder 5. Thus, the projecting portions 112 and 113 are coupled to the base 51 from the Y direction and the direction opposite to the Y direction, with the result that the first coupling member 11 can firmly be coupled to the base 51.

The projecting portion 113 is fixed to the rear walls 51b of the base 51 of the holder 5 by, for example, a plurality of (e.g., two) fixing members S2 (shown in FIG. 6). The fixing members S2 are, for example, configured by bolts and nuts.

The bolts are inserted through, for example, through holes formed in the projection portion 113 and the rear walls 51b of the base 51. The fixing members S2 may be an adhesive or the like. Like the projection portion 113, the projection portion 112 is fixed to the front walls 51a of the base 51 by, for example, a plurality of (e.g., two) fixing members. The fixing members are, for example, configured by bolts and nuts.

The second coupling member 12 couples the output portion 75 of the output member 73 and the rail 81 of the sliding member 8. The output portion 75 of the output member 73, the second coupling member 12, and the rail 81 of the sliding member 8 are arranged in this order in the X direction. The second coupling member 12 is formed of, for example, a metal material, but may be formed of a resin material or the like.

The second coupling member 12 has a column shape extending in the Z direction. The second coupling member 12 has a prism shape (e.g., square prism and hexagonal prism) in one example, but may have other shapes such as a cylinder shape.

The second coupling member 12 is fixed to the output portion 75 and the rail 81 by, for example, a plurality of (e.g., two) fixing members S3. In addition, the fixing members S3 fix the rail 81 and the body portion 111 of the first coupling member 11.

The fixing members S3 are configured by, for example, bolts and nuts. The bolts are inserted through, for example, through holes formed in the output portion 75, the second coupling member 12, the first wall 811 of the rail 81, and the side walls 1112 of the body portion 111. The fixing member S3 may be an adhesive or the like.

As described above, the output portion 75 is coupled to the rail 81 and the body portion 111 of the first coupling member 11 via the second coupling member 12. The body portion 111 of the first coupling member 11 is coupled to the base 51 of the holder 5 via the projecting portions 112 and 113.

Thus, as the output portion 75 of the output member 73 linearly moves along the Z direction and the direction opposite to the Z direction, the rail 81, first coupling member 11, second coupling member 12 and holder 5 also linearly move along the Z direction and the direction opposite to the Z direction. In view of the rail 81, the rail 81 moves linearly in the Z direction and the direction opposite to the Z direction relative to the slider 82, the case 71 of the converting member 7 and the input member 72.

Next is a description of a method of using the agitation apparatus 3 according to the present embodiment. First, the first and second containers 2A and 2B are attached to the holder 5. The first container 2A contains contents 22A and the second container 2B contains contents 22B.

With the first and second containers 2A and 2B attached to the holder 5, the input shaft 74 of the input member 72 is coupled to the output shaft 47 of the power tool 42 via an attachment 41. The input shaft 74 and the output shaft 47 may be coupled to each other before the first and second containers 2A and 2B are attached to the holder 5.

Then, the input shaft 74 of the input member 72 is rotated. More specifically, the input shaft 74 is rotated by the power tool 42 (shown in FIG. 1). As the input shaft 74 rotates about the axis CX1, the output portion 75 of the output member 73 linearly moves along the Z direction and the direction opposite to the Z direction.

As described above, as the output portion 75 moves linearly, the rail 81, first coupling member 11, second coupling member 12 and holder 5 also move linearly. Thus, the first and second containers 2A and 2B attached to the holder 5 move linearly along the Z direction and the direction opposite to the Z direction, as indicated by the arrows in FIG. 4.

As a result, the first and second containers 2A and 2B attached to the holder 5 are shaken along the Z direction and the direction opposite to the Z direction by the agitation apparatus 3, and accordingly the contents 22A and 22B are agitated.

After agitating the contents 22A and 22B, the attachment 41 and the power tool 42 are detached from the agitation apparatus 3. Then, the distal end of the static mixer 62 (shown in FIG. 1) is directed to a work place or a work for coating with polyurea, and the trigger 53 is depressed. At this time, the A agent and B agent are agitated and mixed in the static mixer 62, and the polyurea is sprayed from the spraying hole 62a (shown in FIG. 1).

For example, the user can use the agitation apparatus 3 while holding it by hand. If the user holds the grip 52 of the holder 5 by hand, he or she can perform an agitating operation by the power tool 42 while supporting the agitation apparatus 3.

Since the grip 52 of the holder 5 and the converting member 7 are spaced from each other in the Y direction, the user's operation of the power tool 42 is hardly obstructed. The user can operate the trigger 53 without detaching the power tool 42. Polyurea may be sprayed without detaching the attachment 41 and the power tool 42.

The agitation apparatus 3 configured as described above includes the holder 5 to which the first container 2A is attached and the converting member 7. The converting member 7 includes the input member 72 that rotates about the axis CX1 and the output member 73 that outputs the rotational motion of the input member 72 as a linear motion along the Z direction and the direction opposite to the Z direction. The output member 73 is coupled to the holder 5.

Thus, as the input member 72 rotates about the axis CX1, the output member 73 and the holder 5 move linearly along the Z direction and the direction opposite to the Z direction. As a result, the first container 2A attached to the holder 5 is shaken along the Z direction and the direction opposite to the Z direction, and accordingly the contents 22A of the first container 2A can be agitated. The input member 72 has the input shaft 74 coupled to the output shaft 47 of the rotation driving unit 46 of the driving source. Using the power tool 42 as a driving source, the agitation apparatus 3 can easily perform its agitating operation. Therefore, the first container 2A can be mechanically shaken in the Z direction and the direction opposite to the Z direction by the agitation apparatus 3. The use of the power tool 42 makes it possible to use the agitation apparatus 3 at a desired location.

The contents 22A contain, for example, a plurality of materials having different specific gravities. The contents 22A are contained in the container body 20 elongated in the Z direction. The materials having different specific gravities can be mixed by mechanically shaking the first container 2A in the Z direction and the direction opposite to the Z direction by the agitation apparatus 3. According to the present embodiment, therefore, the contents 22A of the first container 2A can be sprayed satisfactorily.

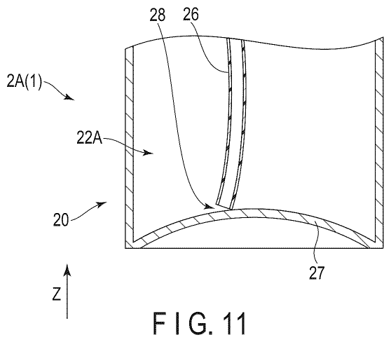

FIG. 11 is a schematic partial sectional view showing an example of the structure of the first container 2A. The first container 2A includes, for example, a tube 26. The tube 26 extends from above the container body 20 toward the bottom wall 27 of the container body 20. The tube 26 corresponds to a flow path through which the contents 22A pass when the valve 21 is opened.

An inlet hole 28 is provided at one end of the tube 26. The portion of the tube 26 including the inlet hole 28 is immersed in the liquid phase of the contents 22A. In the example shown in FIG. 11, the inlet hole 28 is located near the bottom wall 27. The inlet hole 28 is opened toward the bottom wall 27, for example. Therefore, the contents 22A are sucked into the inlet hole 28 from near the bottom wall 27.

The contents 22A may contain pigments, resin components and the like. Since the pigments and resin components have a high specific gravity among the materials constituting the contents 22A, they may precipitate or aggregate on the bottom wall 27 and thus become precipitates.

Therefore, the pigments and resin components may cause the inlet hole 28 to clog and partially or completely block the inlet hole 28. If the contents 22A are mechanically agitated using the agitation apparatus 3, the pigments and resin components can be dispersed in the contents 22A. Accordingly, clogging of the inlet hole 28 by the pigments and resin components is suppressed.

In addition, if the contents 22A are agitated by the agitation apparatus 3, variations in mixing of the pigments and resin components with a plurality of materials can be suppressed. As a result, according to the present embodiment, the contents 22A of the first container 2A can be sprayed satisfactorily.

In the present embodiment, not only the first container 2A but also the second container 2B can be attached to the holder 5 of the agitation apparatus 3 by the first attaching portion 511 and the second attaching portion 512. Thus, the contents 22B of the second container 2B can be agitated together with the contents 22A of the first container 2A.

The second container 2B is configured in the same manner as the first container 2A described with reference to FIG. 11, for example. If, therefore, the contents 22B are mechanically agitated using the agitation apparatus 3, the clogging of the inlet hole 28 can be suppressed in the second container 2B as in the first container 2A.

Furthermore, in the first and second containers 2A and 2B, there is a difference in density between the upper and lower parts of the container body 20, which may be an obstacle to uniform working. In particular, in the case of spraying a two-liquid resin, the mixing ratio of the two liquids to be reacted is affected, and there is a concern that the sprayed resin may not be sufficiently cured as a polymer material because either the main agent or the curing agent is left over in the chemical reaction.

With the present embodiment, variations in mixing of the pigments and resin components with a plurality of materials can be suppressed by agitating the contents 22A and 22B by the agitation apparatus 3. As a result, the mixing ratio of the A agent in the first container 2A and the B agent in the second container 2B can be kept normal for the two-liquid mixing type spraying system 1, and polyurea having desired characteristics can be sprayed.

Since the contents 22A and 22B are agitated by the agitation apparatus 3, agitation conditions such as stroke ST, the number of rotations and agitation time can be predetermined. The user can thus use the agitation apparatus 3 based on the predetermined agitation conditions.

It is thus possible to prevent variations in agitation caused by difference in user. The agitation apparatus 3 facilitates quality control. For example, if a plurality of converting members 7 having different strokes are ST prepared in advance, the user may change the converting members 7 appropriately according to the contents 22A and 22B.

As shown in FIG. 1, the agitation apparatus 3 according to the present embodiment can be applied to the first and second containers 2A and 2B while being attached to the holder 5. It is unnecessary to detach the first and second containers 2A and 2B from the holder 5 for agitation. Thus, the agitating operation can be performed more efficiently.

Since the agitating apparatus 3 has a function as a spraying apparatus, the user can spray polyurea by depressing the trigger 53 after the agitating operation. Thus, the work efficiency in the field can be improved.

In the present embodiment, the agitation apparatus 3 includes the rail 81 and sliding member 8 having a slider 82. The rail 81 is coupled to the output member 73 of the converting member 7, and the slider 82 is coupled to the case 71 of the converting member 7.

Thus, when the output member 73 moves linearly, the holder 5 can be moved linearly with stability. As a result, the first and second containers 2A and 2B attached to the holder 5 can be shaken reliably in the Z direction and the direction opposite to the Z direction.

As described above, according to the present embodiment, the agitation apparatus 3 is capable of spraying the contents of the container satisfactorily. In addition to the above, various preferable functions can be obtained from the present embodiment.

In the present embodiment, as the spraying system 1, a spraying system that sprays polyurea is exemplified. However, the configuration disclosed in the present embodiment can also be applied to a spraying system that sprays other kinds of materials. In this case, the first and second containers 2A and 2B contain appropriate contents to obtain materials to be sprayed.

The number of containers (spray cans) of the spraying system 1 is not limited to two, but may be one or three or more. The shape or the like of the holder 5 is appropriately changed according to the number of containers.

In the present embodiment, the power tool 42 is exemplified as a driving source, but any other tool may be used. For example, a motor and a battery electrically connected to the motor can be used as the driving source.

In the present embodiment, the input shaft 74 of the input member 72 is a solid shaft, but it may be a hollow shaft. The input shaft 74 is coupled to the power tool 42 via the attachment 41, but it may be directly coupled to the power tool 42.

In the present embodiment, the output shaft 47 of the power tool 42 is a hollow shaft, but it may be a solid shaft. The shapes of the input shaft 48 and output shaft 49 of the attachment 41 are appropriately changed in accordance with the shapes of the output shaft 47 and input shaft 74.

In the present embodiment, the axis CX1 of the input member 72 of the converting member 7 extends along the X direction, but it may extend along the Y direction.

In the present embodiment, the rail 81 of the sliding member 8 and the holder 5 are coupled to each other via the first coupling member 11, but they may be directly coupled to each other.

The agitation apparatus 3 may further include a support for supporting the first and second containers 2A and 2B. The support is configured to support the first and second containers 2A and 2B from below, for example.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An agitation apparatus for use in a container which contains contents and extends in a first direction, comprising:
a holder to which the container is attached; and
a converting member coupled to the holder,
wherein:
the converting member includes an input member which rotates about an axis, and an output member coupled to the holder to output a rotational motion of the input member as a linear motion along the first direction and a direction opposite to the first direction; and
when the input member rotates about the axis, the container attached to the holder moves linearly together with the output member in the first direction and a direction opposite to the first direction.

2. The agitation apparatus of claim 1, wherein the input member includes a first input shaft coupled to an output shaft of a rotation driving unit of a driving source.

3. The agitation apparatus of claim 2, wherein the axis extends along a second direction orthogonal to the first direction.

4. The agitation apparatus of claim 3, wherein the output member further includes an output portion coupled to the holder and extending in the first direction.

5. The agitation apparatus of claim 3, further comprising a sliding member,
Wherein:
the sliding member includes a rail extending in the first direction and a slider provided movably along the rail; and
the rail is coupled to the output member of the converting member and linearly moves in the first direction and a direction opposite to the first direction with respect to the input member of the converting member.

6. The agitation apparatus of claim 5, wherein the converting member further includes a case coupled to the slider and contains at least part of the input member and the output member.

7. The agitation apparatus of claim 6, wherein:
the input member projects in a direction opposite to the second direction from the case; and
the output member projects in the first direction from the case.

8. The agitation apparatus of claim 4, wherein:
the input member includes a rotating plate provided at an end portion of the first input shaft to rotate about the axis together with the first input shaft, and a pin provided on the rotating plate, projecting in the second direction and provided away from the axis; and
the output member includes a pin inserting portion connected to the output portion and where the pin is located.

9. The agitation apparatus of claim 5, wherein the holder further includes a grip extending in the first direction and spaced from the rail.

10. The agitation apparatus of claim 1, wherein the holder includes a plurality of attaching portions for attaching a plurality of containers.

11. A spraying system comprising:
the agitation apparatus of claim 1; and
a power tool including a rotation driving unit couplable to the input member.

12. The spraying system of claim 11, further comprising an attachment including a second input shaft couplable to the rotation driving unit and an output shaft couplable to the input member.

13. The spraying system of claim 11, wherein:
the container is a spray can capable of spraying the contents; and
the holder further includes a trigger to operate a valve of the container.

14. The spraying system of claim 13, wherein the agitation apparatus further includes a spraying nozzle attached to the holder and having a spraying hole through which the contents are sprayed.
